(19) United States
(12) Patent Application Publication
(10) Pub. No.: US 2001/0041244 A1
(43) Pub. Date: Nov. 15, 2001

(54) Wooden blind slats

(75) Inventor: Ming Nien, Changhua Hsien (TW)

Correspondence Address: BROWDY AND NEIMARK, P.L.L.C., ATTORNEYS AT LAW, SUITE 300, 624 NINTH STREET, N.W., WASHINGTON, DC, 20001-5303, US

(73) Assignee: NIEN MADE ENTERPRISE CO. LTD., CHANGHUA HSIEN (TW)

(21) Appl. No.: 09/906,650

(22) Filed: Jul. 18, 2001

Related U.S. Application Data
(62) Division of application No. 09/427,663, filed on Oct. 27, 1999.

(51) Int. Cl. B32B 5/12

(52) U.S. Cl. 428/106

(57) ABSTRACT

Wooden blind slats have a length, a width, and a thickness, whereby the wooden blind slats are made of a wooden board which is formed of a plurality of wooden slices, the wooden slices being joined together by an adhesive.

### CROSS-REFERENCE TO RELATED APPLICATIONS

The present application is a divisional of Ser. No. 09/427,663, filed Oct. 27, 1999, the entire contents of which are hereby incorporated by reference.

### FIELD OF THE INVENTION

The present invention relates to wooden blind slats.

### BACKGROUND OF THE INVENTION

Conventional Venetian blind slats are made of aluminum, plastic, or wood. Wooden blind slats are highly desired by consumers, even though they are quite expensive. Wooden blind slats are generally made of basswood and Ramin wood, since the fibers of these woods are straight and resistant to deformation. Ramin wood is a product of the tropical rain forest in Southeast Asia. In light of the adverse impact on the environment of excessive cutting of the forest, products made of Ramin wood are banned in Europe and in the United States. Basswood is grown in a relatively small area and is therefore scarce. Needless to say, blind slats made of basswood are very expensive.

Conventional methods for making wooden blind slats comprises a first step in which a tree trunk is cut into slices, with each slice having a width of two inches, one inch, or 0.5 inch. In other words, there are three specifications for the width of the slices. In addition to the width specifications, the thickness of the slices must be considered. For example, the thickness of the slices having a width of two inches must be no less than 3 mm, whereas the thickness of slices of a width of 1 inch or 0.5 inch must be no less than 2.5 mm. In light of the thickness requirements, material costs cannot be effectively reduced.

### SUMMARY OF THE INVENTION

It is an object of the present invention to provide blind slats which are small in dimension and which are resistant to deformation.

It is another object of the present invention to provide a cost-effective method for making blind slats which are small in dimension and resistant to deformation.

The method of the present invention comprises a first step in which a tree trunk is cut into rectangular slices. Each slice has smooth longitudinal surfaces and sides. Both longitudinal ends of the slices show annual rings of the tree trunk. A plurality of the slices are joined together by an adhesive under high pressure to form a rectangular board, which is then cut from one longitudinal end thereof in a direction perpendicular to the joining surface into a plurality of blind slats of a predetermined thickness. The blind slats are smoothed, covered by a protective coating, and then dried by baking. Each blind slat has two grained longitudinal surfaces.

### BRIEF DESCRIPTION OF THE DRAWINGS

FIG. 1 shows a flow chart of the method of the present invention.

FIG. 2 shows a perspective view of a tree trunk chosen for use in the present invention.

FIG. 3 shows a perspective view of a rectangular slice of a tree trunk according to the present invention.

FIG. 4 shows a perspective view of a rectangular board according to the present invention.

FIG. 5 shows a perspective view of an end product of the present invention.

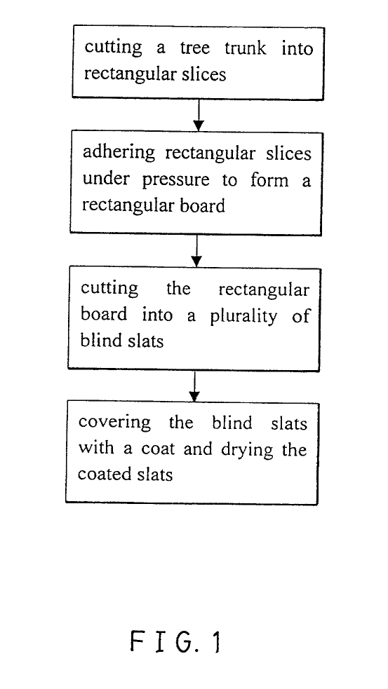

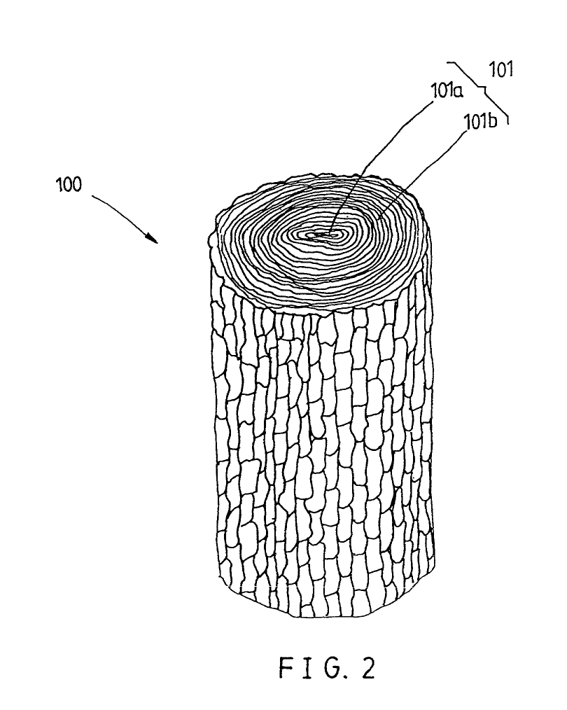

### DETAILED DESCRIPTION OF THE INVENTION

As illustrated in all of the Figures, the method of the present invention begins with a tree trunk 100 which is selected for use as a raw material in the present invention. Only the xylem portion 101 of the tree trunk 100 is actually used in the process. The xylem portion 101 is formed of a heartwood 101a and a sapwood 101b. Both longitudinal ends of the tree trunk 100 display the tree's annual rings. The tree trunk 100 is cut along the longitudinal direction thereof into a plurality of rectangular slices 10, which are so dressed as to have two smooth longitudinal surfaces 11, two smooth longitudinal sides 12, and two smooth longitudinal ends 13 which exhibit a profile of annual rings.

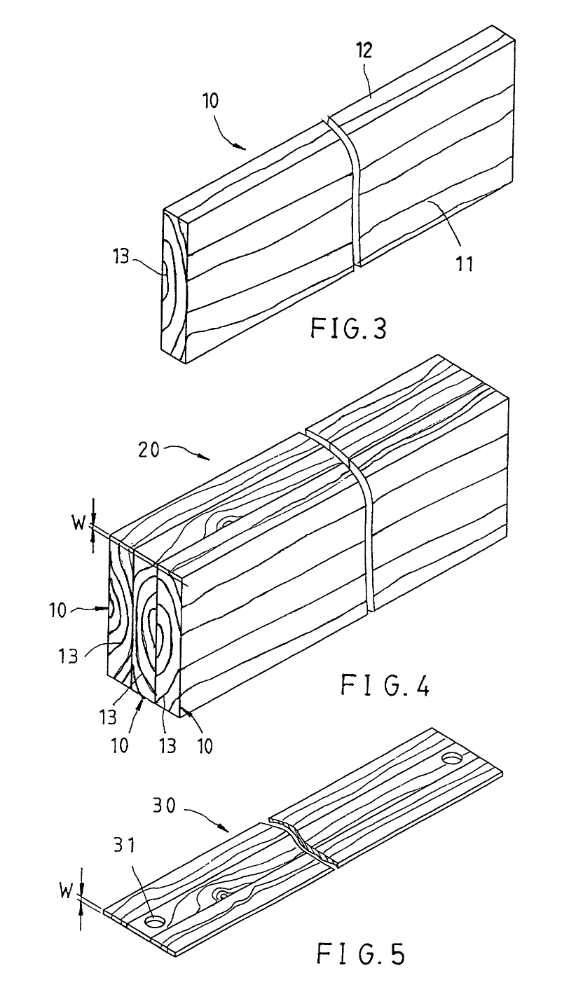

The longitudinal surfaces 11 of a plurality of the rectangular slices 10 are coated with an adhesive before the rectangular slices 10 are randomly joined together under pressure to form a rectangular board 20, as shown in FIG. 4. In view of the rectangular board's being formed of a plurality of the rectangular slices 10 which are joined together at random, both longitudinal ends of the rectangular board are formed of a plurality of the longitudinal ends 13 whose fiber grains are arranged in the opposite direction to provide an optimum resistance to deformation.

The rectangular board 20 is sliced from the longitudinal end 13 in the direction perpendicular to the joining surface of each slice 10 such that the rectangular board 20 is sliced into a plurality of blind slats 30. Each blind slat 30 has a thickness W, as shown in FIG. 5. The blind slats 30 are properly dressed and provided with two through holes 31 which are located in proximity of both longitudinal ends of the blind slats 30 for receiving the cords of the blind. The blind slats 30 are smoother, covered with a coating, and then dried by baking.

The method of the present invention has an advantage over conventional methods for making blind slats. In the process of forming the rectangular board 20 of the present invention, a plurality of the rectangular slices 10 are adhered together at random such that the wood fibers are not arranged in a linear manner, and that the fiber grains of the longitudinal ends 13 of the slices 10 are arranged in the opposite direction so as to result in the effect of cancelling the stress. As a result, blind slats made by the method of the present invention are relatively more resistant to deformation than are blind slats produced by conventional methods. Moreover, the thickness requirement of the blind slats 30 is relatively flexible, such that the thickness of the blind slats is less than 2.1 mm when the width of the blind slats is about 2 inches. The thickness of the blind slats is less than 1.6 mm when the width of the blind slates is about 0.5 inch. As a result, the cost of materials for blind slats made according to the present invention is lower as compared with conventional methods.

It must be noted here that the tree trunk 100 which is used in the method of the present invention can be obtained from fir, pine, or other trees which have a netlike grain or a wavy grain. Thus, there is no need to use trees from endangered tropical forests.

What is claimed is:

1. A wooden blind slat having a length, a width, and a thickness, whereby said wooden blind slat is made of a wooden board which is formed of a plurality of wooden slices, said wooden slices being joined together by an adhesive.

2. The wooden blind slat according to claim 1 wherein said wooden slices are joined together at random such that the grains of two longitudinal ends of two adjoining wooden slices are arranged in the opposite direction.

3. The wooden blind slat according to claim 1 wherein the width of the blind slat is two inches and the thickness is 2.3 mm or less.

4. The wooden blind slat according to claim 1 wherein the width of the blind slat is one inch and the thickness is 2.1 mm or less.

5. The wooden blind slat according to claim 1 wherein the width of the blind slat is 0.5 inch and the thickness is 1.6 mm or less.
